(19) United States
(12) Patent Application Publication
(10) Pub. No.: US 2005/0063569 A1
(43) Pub. Date: Mar. 24, 2005

(54) Method and apparatus for face recognition

(76) Inventors: Charles Colbert, Yellow Springs, OH (US); David K. Perelman-Hall, Cleveland Heights, OH (US)

Correspondence Address: Joseph G. Nauman, 696 Renolda Woods Ct., Dayton, OH, 45429-3415, US

(21) Appl. No.: 10/867,103

(22) Filed: Jun. 14, 2004

Related U.S. Application Data
(60) Provisional application No. 60/478,475, filed on Jun. 13, 2003.

(51) Int. Cl. G06K 9/00

(52) U.S. Cl. 382/118

(57) ABSTRACT

Methods and apparatus are disclosed which are useful in rapidly verifying a person's identity at a distance, and/or identifying a person with a high degree of certitude, from a pool of other persons, using an innovative technique to compare facial images. Such a person (Candidate) may voluntarily consent or cooperate to have his facial image recorded, or the Candidate's facial image may have been recorded involuntarily. Typically, an image recorded for identification purposes will be a facial image of a Candidate present before a camera or other image procuring device, to be compared with a previously stored Reference facial image, as in a building lobby, for identification purposes. The Candidate's facial image is recorded voluntarily but the Reference image is not in the Candidate's possession. Reference images may be stored as Reference templates in an image storage database (such as developed by a governmental agency), or in an entrance lobby to the Candidate's apartment, or in a camera memory installed in a cockpit door of a transit vehicle to prevent access by hijackers. For verification purposes, the Reference facial image may be a hard copy, for example, a driver license, membership card, or passport in the Candidate's possession. A specially modified digital camera significantly reduces the requirement for a large memory to store templates, and makes it feasible to search for and identify rapidly (at distances up to 500 feet) suspects among a group of persons passing into or through such facilities as terminals, vehicles, customs stations, malls, ramps, etc. It is feasible to combine face recognition technology with other biometrics that express the degree of sameness as a numerical match score.

### PRIOR APPLICATION

This application claims the priority of and is based upon, and hereby incorporates by reference the entire disclosure of, U.S. Provisional Application for METHOD AND APPARATUS FOR FACE RECOGNITION; Ser. No. 60/478,475 filed 13 Jun. 2003

### FIELD OF THE INVENTION

This invention relates to biometric methods, systems and equipment for the newly recording of an image, for example a facial image, in connection with anti-terrorist or security activities, for storing the recorded image information in greatly minimized form, and rapidly searching for a match by comparing same with previously stored image information. In the physical security industry (and in this Application) a biometric record characteristic of a person, such as a facial bitmap, fingerprint, retinal pattern, iris pattern, etc., is termed a ‘template’, which is also known as a “slither curve”. The method to generate a template from a biometric image is termed ‘Autocorrelation’ (AT).

### BACKGROUND OF THE INVENTION

1) 1988. First discovery of the potential and use of the AT method (by the assignees to this application) is described in Final Report DEH-TR-89-01 Human Remains Identification Study under contract No. F08635-88-C-0223 submitted in 1989 to the U.S. Air Force, HQ AFESC/DEHM, Tyndall Air Force Base, FL 32403-6001, relating to identification of military air-crash victims and combat casualties, by AT of pre-mortem and postmortem X-ray images. On pages 50 through 57 the Final Report describes how the AT method reduces a two-dimensional chest X-ray image of the spine to a simple curved line (now called a ‘template’) revealing the geometric spacing of the cadavers vertebrae, and how this cadaver's (Candidate) template is rapidly compared (cross-correlated) point-for-point to previously stored (Reference) templates from chest X-rays of certain military personnel, seeking a match, so as to identify the cadaver.

2) 1991. An AT method is described in U.S. Pat. No. 5,073,950, Dec. 17, 1991, col.7, lines 32ff, assigned to Personnel Identification & Entry Access Control Incorporated [PIDIAC], YELLOW SPRINGS OH 45387, (the assignee of this application) as applied to enhancing the shape (profile) of a finger image.

3) 1992. A so-called threshold score is needed to determine the criterion for accepting or rejecting Candidates. Such a score is the value of r² (Pierson's coefficient of determination) which is a measure of sameness. To establish this threshold, Sandia National Laboratories, U.S. Dept. of Energy devised a manual method to evaluate performance of competing access control apparatuses. Holmes, Wright, and Maxwell give a clear and elegant description of the Sandia [Evaluation] Method in Access Control magazine, Vol.35, No.1, January 1992. To assess performance of a biometric apparatus, Sandia investigators assemble a group of 80 to 100 volunteer subjects whose Reference templates are recorded and stored in the apparatus's Reference database. Each volunteer (now a “Candidate”) tries to get accepted against his own Reference template (true matches), while the provisional threshold score is raised from a low setting step by step. Meanwhile, at each incremental step Sandia investigators log the number of correct and erroneous acceptances. A plot of this true match data gives rise to a performance curve of percent error vs. provisional threshold setting. Then these subjects (Candidates) try to get accepted against other volunteers' Reference templates (false matches). As in the true match exercise just described, a plot of this false match data gives rise to a performance curve of percent error vs. provisional threshold setting. By placing the true match and false match performance curves on the same graph (FIG. 10). Their intersection shows the threshold setting at which the true and false error rates are equal. This means that (at the specified threshold setting) the biometric apparatus under evaluation will: 1) equally likely admit an unauthorized person as reject an authorized person; and 2) achieve a performance rating in terms of percent error as shown on the graph. The “crossover error” rating is a Figure of Merit by which different biometric apparatuses may be compared.

It should be noted that the Sandia Method is a set of manual procedures to determine the performance (crossover error rate) of a biometric identification device. Its drawback is that it involves the active participation of the 100 or so subjects over a long time period, and requires tedious labor to tally, record, and plot the graph.

4) 1997. Use of the AT method is described in U.S. Pat. No. 5,594,806 Jan. 14, 1997, col.7, lines 1-22, issued to the assignee to this Application, as applied to encrypting the shape (profile) of a knuckle image.

### SUMMARY OF THE INVENTION

The present invention provides methods and apparatuses which are useful in quickly verifying a person's identity at a distance, or in identifying a person with a high degree of certitude from a pool of other persons, using an innovative technique to compare facial images. Such a person (‘Candidate’) may voluntarily consent or cooperate to have his facial image recorded. Or the Candidate's facial image may have been recorded involuntarily. Typically, an image recorded for identification purposes will be a facial image of a living Candidate present before a camera or the like, to be compared with a previously stored Reference facial image, say, in a building lobby, for identification purposes. The Candidate's living facial image is recorded voluntarily but the Reference image is not in the Candidate's possession. For example, Reference images could be stored as Reference templates in an image storage database developed by a governmental agency, in an entrance lobby to the Candidate's apartment, or in a Camera installed in an aircraft cockpit door to prevent access by hijackers. For verification purposes, the Reference facial image may be a hard copy, for example, a driver license, membership card, or passport in the Candidate's possession.

The specially modified Camera described in this Application significantly reduces the requirement for a large memory to store templates, and makes it feasible to search and identify rapidly (at distances up to 500 feet) for suspects among a group of persons passing into or through such facilities as airport, rail and bus terminals, aircraft, ships, loading docks, customs stations, malls, ramps, etc. To increase likelihood of achieving identification, it is also feasible in certain circumstances to combine (or fuse) face recognition technology with other biometrics that express the degree of sameness as a numerical match score, such as the knuckle ID apparatus described U.S. Pat. No. 5,594,806 and assigned to the Assignee of this application.

### BRIEF DESCRIPTION OF THE DRAWINGS

FIG. 1 is a perspective view of a typical digital camera, which may be used as the scanning input to a system according to the invention.

FIG. 2 is a view of the rear of the camera showing the optional LCD viewing screen and the cable over which a serial digital output is provided.

FIG. 3 is a view of a converter box for housing the Digital Signal Processor (DSP) circuitry, which receives the image bitmap data from the Camera and processes that information into template format for storage and/or comparison.

FIG. 4 is a block diagram of the system showing its functions.

FIG. 5 is a schematic view of a typical installation of the system on an access door.

FIG. 6 is a frontal facial view of a Candidate as may be recorded and processed by the system.

FIG. 7 is a representation of a typical template (slither curve).

FIG. 8 is a diagram showing where the clone is located relative to the parent image at the start of a scan in the vertical direction.

FIG. 9 is a further diagram illustrating location of the clone when displaced five lines from the start of the image scanning process.

FIG. 10 is a typical Sandia crossover error rate graph being used to evaluate and compare performances of one of several competitive biometric apparatuses.

FIG. 11 is a typical computer-generated PIDEAC crossover error rate graph.

FIGS. 12A, 12B, and 12C (Prior Art) show typical correlation or match curves.

### GENERAL DETAILED DESCRIPTION OF THE INVENTION

In view of past experience with the sheer power, versatility, and attributes of AT, the assignee of this Application has adapted and extended the principles of AT to recognizing the features of a facial image, as distinct from a knuckle profile. A digital camera is considered an instrument of choice for recording the Candidate's facial image, but of course other digital imaging devices might be used. One embodiment of the system and equipment is a digital Face Recognition Camera (‘Camera’) with certain built-in Autocorrelation Transform (AT) features to facilitate identification or verification of a person whose facial image has been previously photographed and stored for later reference.

The Autocorrelation Transform (AT) is the underlying concept to face recognition used in this Application, believed to be distinguished from all other known methods. AT compresses a facial image, forming a “template” (Fig. YY) (formerly termed a “slither curve” in the Background citations above). A template produced by AT has many attributes in addition to image compression. The Autocorrelation Transform method does not require any prior preparation of the images such as selective placing of dots on the facial images for measuring distance between dots to build a “bridge” structure (as featured by one manufacturer's apparatus, FIG. 6). On the contrary, AT automatically uses the entire image content for face recognition, not just an arbitrary and limited number of selected points or regions.

### Vertical Clone Scan Direction

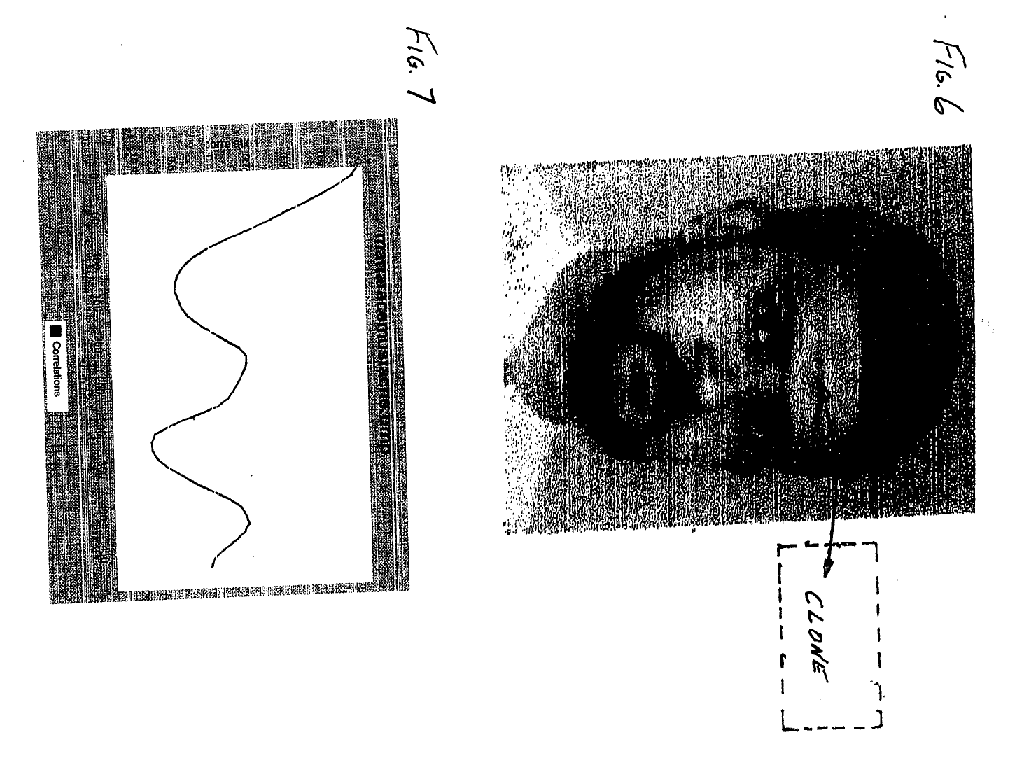

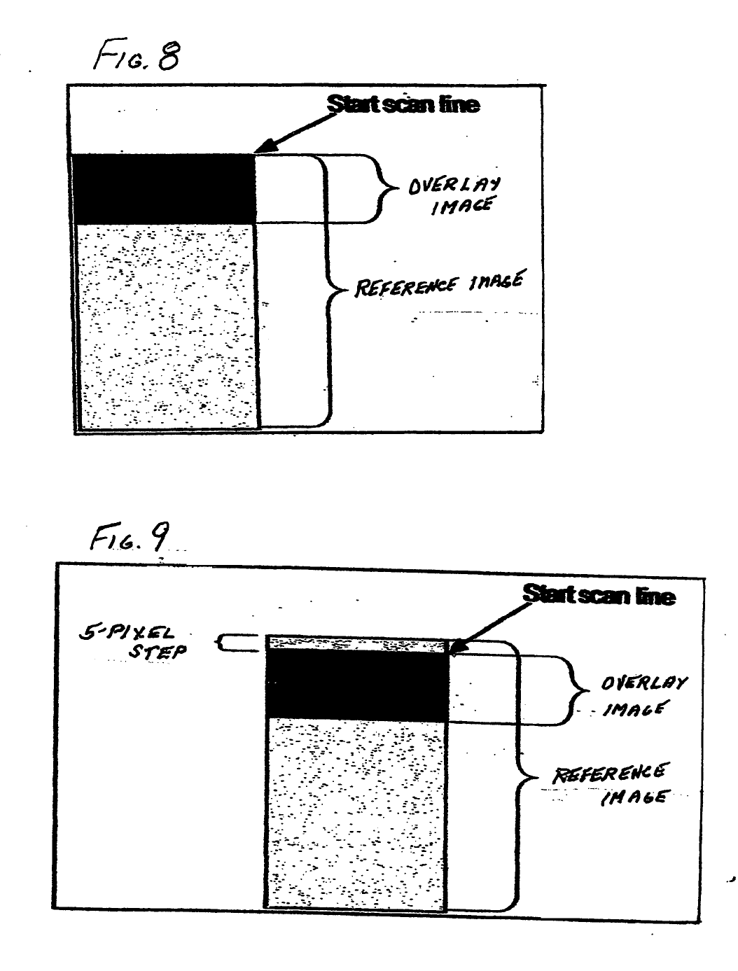

The following describes how AT generates a template.
1. The Camera photographs a face and stores the image in memory (TMM) as a bitmap of, say, 500 KB (kilobytes).
2. The image is a two-dimensional mosaic of picture elements (pixels), arranged in 500 lines to be read from memory line-by-line.
3. Beginning with the 500-line bitmap (the parent image), AT duplicates (i.e., clones) a portion (say, 25%) of the parent image comprising a 125-line rectangle enclosing the hairline, forehead and eyebrows.
4. AT compares the clone with the parent image and computes Pearson's coefficient of determination (r²), a measure of sameness. At the start r²=1.000 (or 100 in decimal notation) denoting a perfect match.
5. Next, AT shifts the clone vertically down the face toward the chin, progressively out of register with the parent image in 50 successive steps.
6. At each successive displacement, AT computes a new value of r², declining from 100 as the clone departs from register.
7. Thus, AT generates a sequence of 50 r² values (points) which when connected form a “template” (FIG. 7), an irregular curve whose undulations result from the particular physical layout (“map”) of a person's facial features, i.e., the shapes and relative locations of the eyes, eyebrows, nose, lips, chin, moustache, etc. Alternatively, a clone could be formed at the chin and scanned vertically upward toward the forehead. It is extremely unlikely that two persons would have identical or very similar templates, except possibly identical twins.
8. A template of 50 points is not sacred. Alternatively, Users can choose the number of clone steps anywhere from 1 point to 20, so the template can comprise anywhere from 500 points to 25 points. In most instances a 500-point template will be unnecessarily detailed and will slow down the face recognition process, whereas 25 clone steps will create a 25-point template that y required to store a template. but may be too coarse, failing to will speed up identification time and decrease the memor account for important facial features. A 50-point template appears to be a suitable compromise for most security applications. A template is also useful because it encrypts a 0.5 MB facial image and compresses it by a factor of 10,000:1 or more, thus drastically reducing memory storage requirements.

### Compression Ratio

A template is a unique representation of a two-dimensional facial image, that rapidly compresses a facial bitmap image of, say, 500 kilobytes (approximately 5×10⁵×8=4×10⁶ bits) to a mere 50 points, or so. If each template point is represented by an 8-bit word, a template comprises 400=4×10² bits. The compression ratio is 10,000:1.

### Horizontal Clone Scan Direction

This feature offers a solution to the head rotation problem whenever Candidate and Reference images are not oriented at the same angle. Rotating the bitmap 90° (electronically) creates a new clone that moves horizontally (laterally) across the face to generate a different template, thus adding new diagnostic information to the face recognition process. This lateral (“ear-to-ear”) template will be less susceptible to match failure than the vertical “forehead-to-chin” template.

Suppose a vertical clone scan as described above where the Candidate's head and the Reference head of the same person are both facing frontally, or else at the same angular orientation with respect to the Camera. If so, the resulting templates will match, showing they are of the same person. However, if the heads are not at the same rotational angle, the existence of some features (e.g., a moustache) might appear in, say, the Reference template and not in the Candidate template, thereby degrading the match score, and possibly leading to an erroneous conclusion they are not of the same person. This angular orientation problem is remedied by electronically rotating the Candidate and Reference templates, making it more likely that certain facial features will remain stable despite head rotation. In short, the horizontal clone scan direction is likely to be less sensitive to head orientation than the vertical. Yet another solution to the head orientation problem is to substitute a stereo camera version of the Face Recognition Camera for the Candidate image with appropriate rotation software (such as used in animation) to reorient the Candidate image.

The Camera photographs several persons' faces, produces their Reference templates, and stores them in a Reference database. The Camera's function is to recognize and accept the template of a person newly photographed (if this Candidate's template matches one of the templates in the Reference database) and to reject the others. To do this, the Camera produces a template of the Candidate and compares it in turn to each of the Reference templates, producing numerical match scores. Presumably, the highest match score reveals the identity of the Candidate, but not necessarily. Suppose the Candidate is not represented among the templates in the database. Although there will be a highest scoring template in the database, it cannot be the Candidate's. To prevent the Camera from mistakenly denying access to an authorized person (a Type 1 error), or admitting an imposter (a Type 2 error), the highest match score must equal or exceed a threshold score the User has preset within the Camera. This Application describes below a separate Threshold Score Program for the User who must specify and install the threshold score depending on the degree of security required.

### Comparing a Candidate Template to a Reference Template

Face recognition templates are defined in two ways depending on their use: ‘Reference templates’ have been previously stored in the Camera's Reference database (RDB) and retrieved for later comparison to a ‘Candidate template’ to determine whether they are of the same person. A Candidate template is usually stored in the Camera's Temporary memory) and then deleted from memory when the identification or verification comparison is completed.

### Cross-Correlation

The following explains how a Reference template and a Candidate template are matched (cross-correlated) to see if they are of the same person. The Camera has a built-in cross-correlation algorithm (Pearson's r²) to compare (and try to match) the shapes of the two templates point-for-point. If the shapes are identical, Pearson's coefficient of determination r²=1.000 (or 100 in decimal notation). If they are nearly the same shape, r²<100, but still high. In practice, values as low as 85 may still be considered a match, depending on how tight (stringent) the security requirements are. Users can set a threshold score inside the Camera, below which a Candidate will be rejected.

### Threshold Score

Any biometric access control apparatus (in the present instance, the Face Recognition Camera) can make two kinds of mistakes. It can reject an authorized person (Type1 error), or it can accept an unauthorized person (Type 2 error). The Face Recognition Camera can be a commercially available solid state digital camera modified with a Digital Signal Processor (DSP) circuit board to generate a Candidate template, then compare a Candidate's template to a previously recorded Reference template retrieved from Reference memory. To do this comparison, it computes Pearson's r², the coefficient of determination, a measure of sameness mentioned above. If the two templates are of the same person, it is expected that the value of r² will be close to 100 (i.e., a perfect point-for-point match). In practice, such a match score is usually in the range 85 to 99 but rarely perfect due, among other factors, to differences in highlights and shadows. But, how high must a match score r² value be for the Camera to judge the Reference and Candidate templates to be of the same person? The next section describes a separate program Users can use to find the threshold score, the accept/reject criterion, they will install within the Camera.

### Determining the Threshold Score

The following explains how the present invention determines the r² value of the threshold score, the criterion by which Candidates are accepted or rejected. This is termed herein as the PIDEAC Method. Once established, the User installs this threshold score in the Camera.

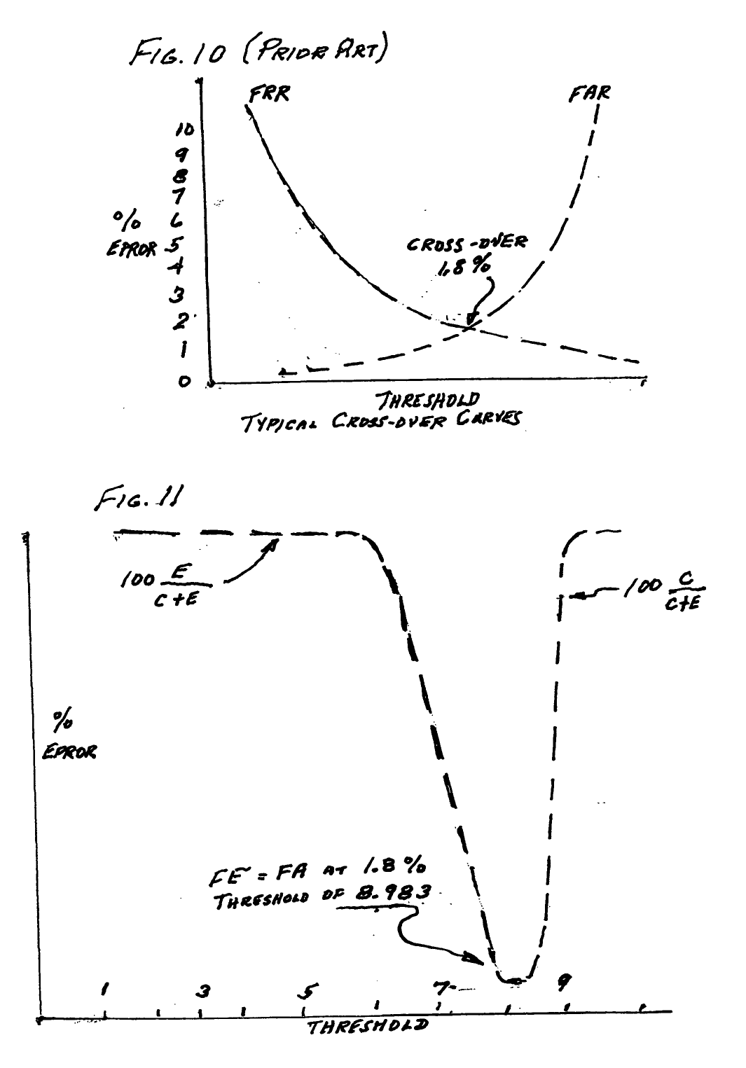

The PIDEAC Method is patterned after the Sandia Method, but differs significantly in that it avoids the tedium of the manual method and constitutes an efficient, standardized computer Error Rate Program to find the Threshold in which volunteer subjects are involved only to the extent that their images are recorded and templates generated at least twice, first as the Reference template and second as the Candidate template. The computer does all the rest: it plots the data, determines the threshold setting, and rates performance of the biometric apparatus under evaluation (FIG. 11) without involving further participation of the subjects. Once Users determine the threshold score they install it in the Camera.

It is no problem for a computer to execute the enormous number of false matches, but it is a logistics burden to execute this task manually. Sandia's manual method could discourage authorities from exploiting all possible false matches because of forbidding time and expense, thus leading to a compromised Error Rate evaluation. Besides, an overlong manual evaluation could cause some subjects to drop out.

In addition to relieving tedium, the PIDEAC Method has these attributes:
1) During the design phase of a biometric device like the Camera, if designers have a choice of two or more algorithms to express sameness, they can use the equal error threshold setting to help them adopt the algorithm that yields the lowest error rate; and
2) As a standardized program to compare error rates of different biometric devices, this would eliminate the confusion that results when manufacturers quote error rates of their products arrived at by using different test protocols.
3) The computerized method gets the best possible error rate evaluation of a biometric apparatus, because the standardized program takes the fullest advantage of the 100 or so volunteer subjects to find the “equal error” Figure of Merit for the apparatus. Investigators using the manual method are not likely to perform the complete 19,800 false matches required in the example (see below) because of time and expense considerations. If investigators do not do the exhaustive number of false matches possible, they will likely arrive at a Figure of Merit more optimistic than the reality.

Users or investigators can use the following equations to ascertain the number of true and false match scores required to find the threshold score, or assess the performance of the Camera since they have decided on the number (n) of volunteer subjects and the number (m) of times their templates are to be recorded.

Assume n=100 volunteer subjects are recruited, and their facial bitmaps are recorded as a pair on two different occasions (i.e., m=2); the first is assigned as the Reference image, the second as the Candidate image.
1) The camera produces and stores in computer memory a total of nm=200 templates (100 Reference and 100 Candidate
2) The Threshold Program matches (cross-correlates) each pair of templates.
3) Eqation 1 is a general equation for optional values of m and n:
4)
   nm(m−1)/2 Eq. 1.
5) From Eq. 1 the total number of true match scores (r²)=100:
6) Next, the Program cross-correlates each of the 100 Reference templates with all 100 Candidate templates
7) Equation 2 is a general equation for optional values of m and n:
8)
   nm−1)/2−nm(m−1)/2 Eq. 2.
9) From Eq. 2 the total number of false match scores (r²)=19,800, and
10) The total number of all possible scores is 19,900.
11) The distribution of the 100 true match scores is likely to be high, perhaps mostly in the range from 85 to 99 since they are matches of the same person.
12) The distribution of the 19.800 false r² match scores is likely to center around some low value, such as 20, since each are matches of two different persons.

### Scale Correction

In general the Reference and Candidate facial images will not be the same size. The following is a description of suitable automatic methods to adjust for differences in image size. The facial features least likely to be obscured are the eyes. So, a first priority is to locate the eyes automatically, and then to measure automatically the distance between the eyes, which cannot be altered by any disguise. Following are some ways to consider/achieve scale correction:

1. This describes an alternative method to cross-correlating Candidate and Reference Templates and obviate scaling corrections. An early idea for ID, incorporated as a part of this invention, is to slide one image across the other stepwise and compute the correlation coefficient at each step. Two identical images will yield a correlation curve vs. displacement that is perfectly symmetrical about its midpoint (FIG. 13). Thus, by folding the left side over the right, the differences are all zeroes. If the images are not identical, the asymmetry will show up as local non-zeroes. Instead of sliding the entire two-dimensional facial image, it will save much computation to slide the Candidate Template across the Reference Template, and to test for symmetry about the midpoint of the resulting correlation curve. If the sizes and facial features of the original facial images were only moderately different, the disparities may not seriously disrupt symmetry of the correlation curve, and could ignore modest facial discrepancies/disguises, such as presence or absence of a moustache.

2. As the clone shifts stepwise vertically downward from the forehead, it will encounter the eye region where the nose bridge will appear for several steps with the eye images straddling the nose. Once the eye region is located, a new “mini-clone” is formed that captures the left or right) eye image and autocorrelates the eye image horizontally in steps until it comes into congruence with the adjacent (right or left) eye image. Even though the two images are not comparing the same eye, the autocorrelation template thus generated will peak revealing the distance between the eyes. (This is the same procedure used to find the separation between vertebrae in the spinal column to identify combat and military air-crash casualties. See Human Remains Identification Study, 1988 cited in the Background of the Invention. Also, one company offers FFE SDK, a software solution, which automatically finds the eyes. It “localizes face on the image, and extracts eyes and mouth for scaling.”

4. Consider a line scan of the original facial bit map from forehead to chin. As the successive lines are read they will soon cut a swath across the nose bridge. The scans will recognize the nose as the face's vertical axis of symmetry straddled by the region encompassing the eyes, a sequence of scan lines defining the swath, and integrating them into a single average line. Now consider the two eye images (side by side) as two adjacent vertebrae. Next clone the first eye image and autocorrelate it by placing it on the parent eye image and slide it laterally across until it encounters the adjacent eye image, whereupon there will be a peak in the resulting template. The distance between the start at r²=1.0 and the peak is the separation between the eyes. This procedure of a few milliseconds to locate the eyes takes place after a relatively few scans of the facial bitmap and does not disrupt the Autocorrelation routine.

### Description of the Preferred System Embodiments

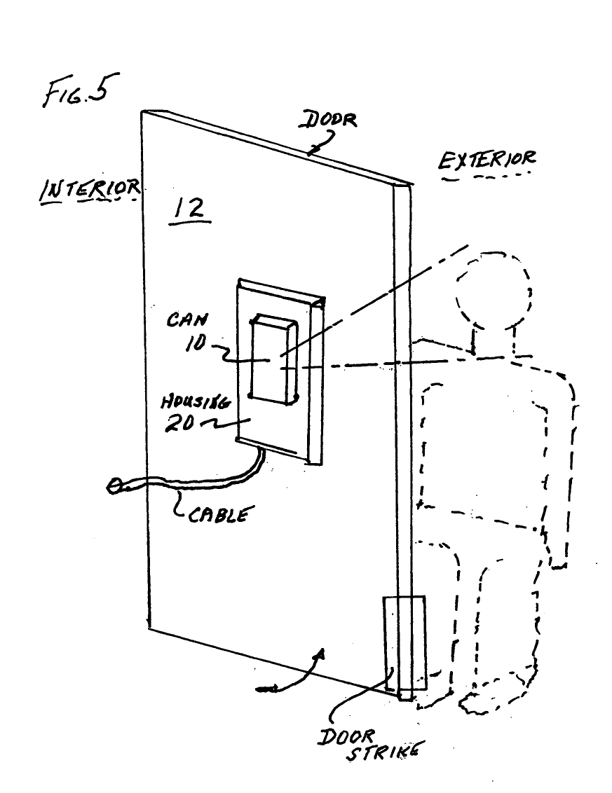

The system apparatus comprises a digital camera CAM 10, preferably high resolution (black and white), or equivalent apparatus, which can record the image of a Candidate's face. A 500 KB memory is sufficient to record a facial bitmap for the AT process. Camera 10 can be installed in a suitable location, for example an entryway (a door 12 as shown in FIG. 5, a gate, etc.). A tripod or any suitable mount is capable of being attached to the camera body. A conventional serial output cable 15 is normally attached to the camera.

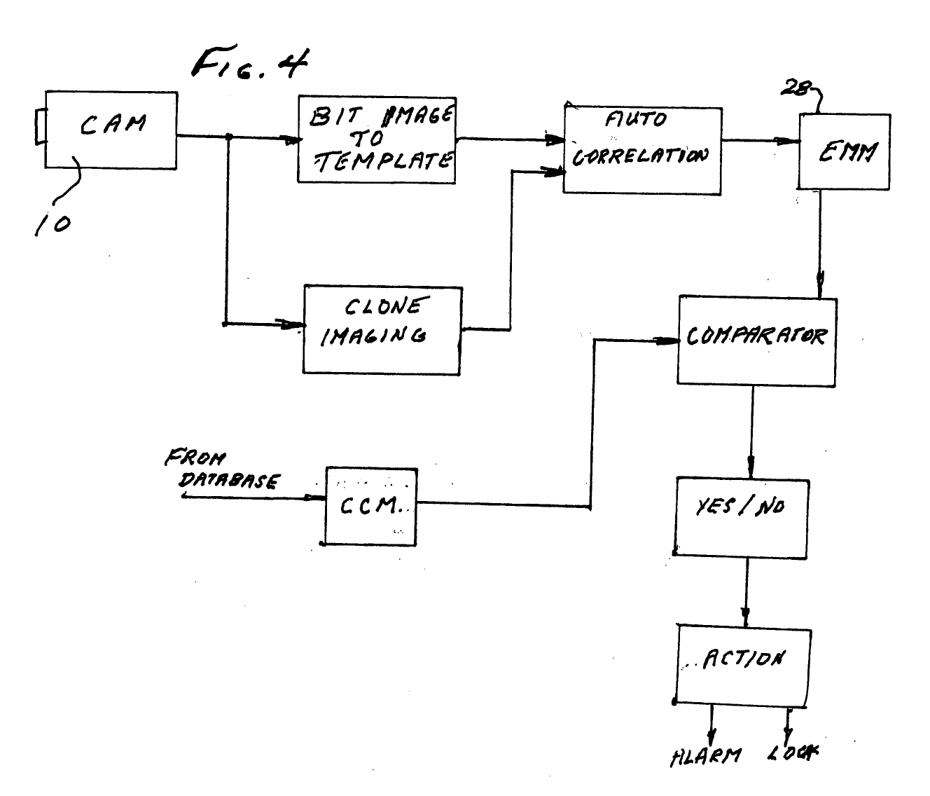

A housing 20 (FIG. 3), built into, or remote from the Camera, includes a circuit which accepts the facial bitmap from the Camera and, (a) clones a selected sub-area of the parent facial image of a person, (b) displaces the clone stepwise relative to the parent facial image, (c) compares (correlates) the clone image with the person's facial image at each step to generate an autocorrelation template whose shape uniquely describes the person's face, and (d) enrolls the person's template in a Reference database memory 22 where Reference templates of other persons are also stored, for later comparison for identification purposes to a Candidate template.

The capacity of the enrolled and identified templates can be local, e.g. memory storage 22, for example limited to a single facility. The memory 22 can be networked with other local or remote memory facilities.

The cross-correlation technique will greatly accelerate rapid comparison of a single Candidate's template to thousands of enrolled templates in a Reference database. When a newly generated Candidate's template is cross-correlated with the Candidate's previously stored Reference template and, if found to be highly correlated, the Candidate is authorized to gain entry. Acceptance or rejection can be signaled by a green lamp 23 or a red lamp 24, and/or by activating or deactivating a door lock. A yellow warning light 25, may signal that the Candidate is being detained as a suspicious person

### Detecting Disguises

The apparatus and circuitry can detect a disguise by the following procedure: Reference and Candidate templates are subtracted point-for-point and the difference record is stored by the DSP circuit in temporary memory. Since the Candidate template shape will have been perturbed by any disguise (moustache, beard, etc.) only one or more segment(s) of the difference record will be unaffected, showing relatively small differences. The DSP circuit cross-correlates only the unaffected segments of the Reference and Candidate templates.

If the disguise is relatively minor (eyeglasses for instance), the rims will be obscured by reducing the bitmap image resolution (i.e., blurring by a smoothing algorithm). In effect, this action would erase or overlook the disguise, concluding that the Candidate and the Reference images are of the same person. This emphasizes an important attribute of cross-correlating these templates: the process does not demand a perfect match for successful performance. In other words, it can be forgiving of certain differences between two images, by adjusting the threshold score within the Camera to suit any particular degree of security. An obvious application of this invention is to prevent terrorists from gaining access to restricted zones, or to identify them when they traverse a seemingly innocuous area at a distance remote from the Camera.

This invention is superior to other methods that must extract salient “multiple-points”. The AT method automatically uses features of the entire facial image without requiring any preprocessing to select salient features.

### Camera Simulator

The Camera Simulator is a desktop Console that mimics the actual Camera in that it contains all the Camera circuitry, except that it does not take. photos. Instead it acquires photos from a scanner (photos of terrorists and/or private citizens) for research, and for demonstrations. The console could be used by intelligence agency Photo Analysts. It uses the same circuitry as the Camera but is not portable. The agency could use it for removing or. The only difference between the Simulator computer program and the Camera DSP circuitry is that the desktop Simulator allows the User/Camera Designer or agency Photo Analyst to interact by selecting a clone size, how many clone steps to take in generating the template, where to place the clone over the parent bitmap at the start of the scan, etc., whereas all these parameters can be set within the Camera by the User/Designer to suit a particular installation and its security requirements. For instance, the Photo Analyst may want to adjust the Simulator version to generate and print out a highly detailed template of many steps. A User may want the Camera DSP circuitry to produce the shortest template consistent with quick, reliable ID performance without any need for printout. Or, the Photo Analyst may want the Simulator to produce a low resolution or blurred bitmap to simulate a telephoto lens image from a person at a distance remote from the camera, else to see if blurring will wipe out the effect of an eyeglass disguise.

The process of scanning a person's image involves the following steps, which can be provided as a program encoded into a programmable DSP (RAM) chip attached to the Camera CAM. It is assumed here that the Reference image is a color bit map image.
Step 1. Access the entire bit map image (Reference image) and store it into a memory, which may be manipulated via a reference pointer.
Step 2. Establish the starting scan line of the Parent image against which the ensuing image correlation will take place. This starting scan line can be designated by the User or by the computer, but must be present for the algorithm to work.
Step 3. Establish the height and width dimensions of the clone (an overlay image), which will be correlated against the Parent image. The dimensions can be designated by a User or by a Camera circuit.
Step 4. The clone can be located anywhere within the bounds of the Parent image. FIG. 8 depicts the overlay image docked against the top of the parent image, but there is no constraint about the initial location of the clone so long as it lies within the parent image.
Step 5. Grab the clone into a memory manipulated by a reference pointer.
Step 6. Calculate the image width and height of the clone, and call these together the clone dimensions.
Step 7. Using the reference pointer of the clone, convert the pixel values of the clone into a vector of 64-bit double values that represent the RGB quotient of a pixel such that there is a single double value for each pixel in the clone. This will be the overlay vector, which is computed only one time.
Step 8. Designate a step made of regular pixel intervals as determined either by a User or the Camera circuit. Example steps would be a one pixel-step, a two-pixel step, or a five-pixel step.
Step 9. Calculate a duration comprised of steps as follows:
a. Take either the complete length, width, or height of the parent image, referred to reference dimension as designated by the user or the computer.
b. If the reference dimension was the width of the parent image, subtract from the reference dimension the width of the clone, and call the result the final reference dimension. If the reference dimension was the height of the parent image, subtract from the reference dimension the height of the clone, and call the result the final reference dimension.
c. The duration will be the result of dividing the final reference dimension by the interval step size, or the number of steps within the final reference dimension.
Step 10. The algorithm computes the correlation of reference and clone images by:
   a. Commencing from the starting scan line of the parent image and using the reference pointer of the parent image, access the portion of the parent image exactly the size of the clone dimensions and store it into a memory manipulable with a reference pointer. Call this the temporary parent image.
b. Using the reference pointer of the temporary parent image, convert the pixel values of the temporary parent image into a vector of 64-bit double values that represent the RGB quotient of the pixels, such that for the portion of the temporary image there is a single double value for each pixel in the temporary parent image.
c. using the vector of double values from the temporary and clone images, compute Pearson's Coefficient of Correlation between the values of the two vectors.
d. Store computed correlation value in a vector for later reference by the application.
e. Move the starting scan line of the parent image one pixel step of designated direction, or terminate if the duration has been completed.

The application then makes the resulting vector of correlation values available for inspection in both tabular and graphical forms.

A program (described above) installs the threshold score in the recognition software to determine whether the threshold score has been met. This separate process is called the “crossover error rate” program.

A biometric access control apparatus such as the Face Recognition Camera can make two kinds of mistakes. It can deny entry access to an authorized person (Type I error); or it can grant access to an unauthorized person (Type 2 error). A typical digital camera apparatus & associated DSP (computer chip), will have compressed each of several previously photographed facial images to a Reference template and stored the templates in the camera's memory When the Camera photographs a new face, it generates a Candidate template. it seeks to know if this template matches any of the previously stored Reference templates in Camera memory. The DSP circuit retrieves each Reference template, in turn, from memory and compares it to the Candidate template point-for-point. If Pearson's cross correlation coefficient r² equals or exceeds the Threshold Score, the Candidate has been identified. In practice, such a match score is usually in the range 0.900 to 1.000, but rarely perfect due differences in highlights and shadows.

### Threshold Score

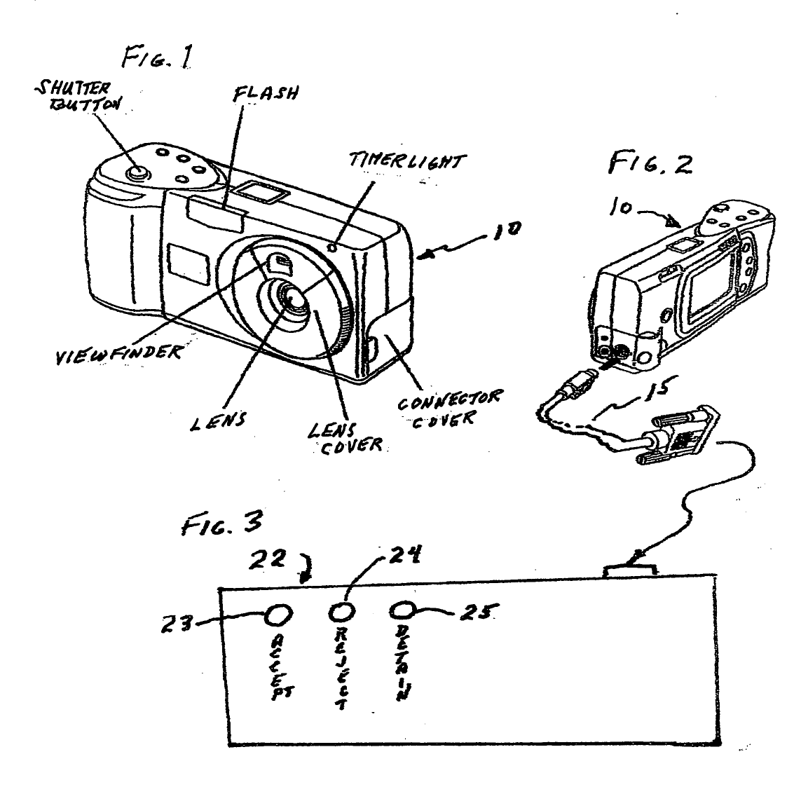

What value of threshold r² should be set within the apparatus to govern whether a Candidate seeking to gain entry should be accepted or rejected? To establish a threshold, an accepted method is to test a group of, say, 100 volunteer subjects who agree to have their facial images recorded by the apparatus on two different occasions. The apparatus then produces a pair of templates for each numbered subject and stores all 200 in the memory of the Threshold Score Program, a separate computer program for use by the Camera Designers. To mimic an actual entry activity, the first templates are designated the Reference templates, and the second templates are designated the Candidate templates.
Step 1. When the Threshold Score Program compares (correlates) the Reference template with the Candidate template of the same volunteer subject, it obtain 100 values of r², called “true matches.” Each value indicates how much alike the two face images are. These values (true match scores) are generally high, ranging from 0.900 to 0.990.
Step 2. The Program adopts a very low provisional threshold score, say, 0.852. 850 and tests whether the true match score of Candidate No. I is less than the threshold, and would therefore be rejected.
Step 3. The Program repeats for all Candidates Nos.2 through 100. Observe that no Candidates are rejected.
Step 4. Now the Program increases the provisional threshold score in equal incremental steps: 0.8.52, 0.854, 0.856, etc. Observe that eventually the provisional threshold score will rise high enough to erroneously reject some true matches. And finally the provisional threshold will reach a level where 100% of the Candidate's match scores will lie below the threshold, and all will be erroneously rejected.
Step 5. For each Candidate's true match score, the Program computes the percentage of Candidates who would be erroneously rejected at each provisional threshold setting.
Step 6. The Program produces a graph (FIG. 1) showing the Percent Erroneous Rejections of true Matches (on y-axis) versus corresponding provisional threshold settings. This gives rise to an error rate curve (FIG. 1) that rises from zero erroneous rejections to 100% rejections at the highest threshold settings. Such erroneous rejections are termed Type 1 errors in which an authorized person is denied access, like preventing the Commanding General from entering his own office, or a coke machine rejecting a perfectly genuine quarter.
Step 7. Program next matches each of the 200 templates with every other template, except the 200 true matches already discussed above. There are 19,800 of these false matches. As the provisional threshold score begins to rise from an initial very low value, 100% of these false match scores are at first erroneously accepted, but this soon diminishes. This gives rise to an error rate curve (FIG. 1) showing the Percent Error Acceptance Rate of false matches that declines from 100% erroneous acceptances to zero. Such erroneous acceptances are termed Type 2 errors in which an unauthorized person is granted access. like admitting a spy to the Commanding General's office, or a coke machine accepting a slug instead of a quarter.
Step 8. FIG. 1 combines the Percent Erroneous Rejection and Percent Erroneous Acceptance curves to reveal their intersection. This point shows the Camera system error when the Typel and Type 2 threshold settings (within the Camera) are equal. The “equal error threshold score”, a figure of merit that specifies the performance quality of the Camera system, can be used to compare one system with another. However, it should be noted that depending upon the security requirements of a given installation, the threshold setting can be changed, if for example, it is more important to deny access to a spy than it is to risk annoying the Commanding General.

### Horizontal Scan Direction: Head Rotation Problem

The following feature description offers a solution to a potential head rotation problem, should the angular orientations of the facial images be different. Assume the clone moves vertically, either forehead down or chin up, generating Reference and Candidate templates of the same person. The resulting match score will show they are of the same person.

However, if the heads are not oriented at the same rotational angle, the existence of a moustache, beard, other facial feature, or a disguise, could be missed, and the match score could be degraded resulting in a conclusion that the templates are not of the same person. This problem is remedied by electronically rotating the Candidate and Reference bit maps 90 degrees so that a new clone now moves from side-to-side across the face. In this case, a perturbation in the templates, say, from a moustache, will persist even if there is some degree of angular disparity between Candidate and Reference templates. In short, the “orthogonal side-to-side scan direction is likely to be less sensitive to head orientation than the vertical scan direction.

### Flow Chart

The Flow Chart depends upon (i.e. is related to) the particular use of the Camera, whether it guards a door for ID, or whether it is for verification at a checkout counter. or entry way where the Camera is installed in a door or viewing a passage.
1) an appropriately authorized person approaches the door, and presses a concealed ENROLL MODE Button;
2) whereupon the Camera records the person's facial bit map;
3) then the Camera automatically reverts to ACTIVE MODE;
4) the person's bit map image is acquired by the DSP (Digital Signal Processing) chip (or board); which
5) produces the person's template; and
6) stores it in the Camera's memory where other authorized templates have already been stored;
7) when any person approaches the door; the Camera (being in ACTIVE MODE) captures the person's facial bitmap; and
8) produces a template; which it promptly cross-correlates, in turn, with each authorized template in the Camera's memory.
   The result is
9) an array of Match Scores; which
10) are compared with a preset Threshold Score;
11) the person is suitably identified as an authorized person and accepted, if his Match Score equals or exceeds the Threshold Score; and
12) upon receiving the acceptance signal a circuit unlatches a door lock mechanism.

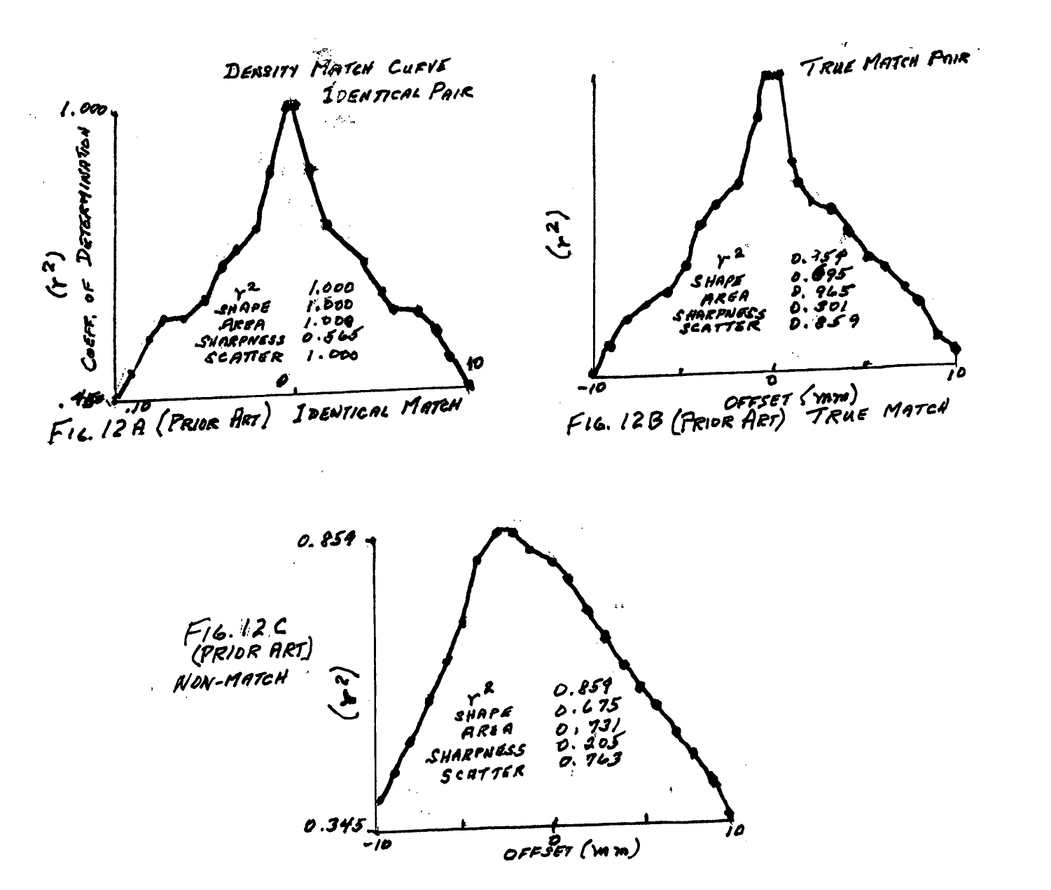

In FIGS. 12A, 12B and 12C, respectively, the illustrated curves (derived from prior art) represent an identical match in FIG. 12A, a “true” match in FIG. 12B, and a mismatch in FIG. 12C which would cause a rejection. For purposes of explanation, the U.S.A.F. Report (referenced in the Background) established that an identical match results when successive values of r² reach a peak of unity at perfect register, since every value on one profile is exactly equal to the corresponding value on the other profile. There is no scatter about the regression line. The identical match curve (an autocorrelation) is perfectly symmetrical about the peak.

A true match results from comparing a pair of profiles derived from different radiographs of the same individual. Differences between these profiles are due to actual difference in the images caused by X-ray technique aging, disease, and hand placement, and to minor scanning variations. Even when the profiles are in correct alignment, such differences create scatter about the regression line and the peak r² at register is at less than unity. The true match curve (a cross-correlation) is mildly asymmetrical

A no-match results from comparison of a pair of profiles derived from radiographs of different individuals. Generally there os considerable scatter at register and the peak r² is lower than that of a true match. The asymmetry of a non-match curve is usually more pronounced than that of a true match curve.

While the method(s) herein described, and the form(s) of apparatus for carrying this (these) method(s) into effect, constitute preferred embodiments of this invention, it is to be understood that the invention is not limited to this (these) precise method(s) and form(s) of apparatus, and that changes may be made in either without departing from the scope of the invention, which is defined in the appended claims.

1. A method of identifying an individual based on a facial image, comprising the steps of
a) preparing a bit map of the individual Candidate's face,
b) creating a clone partial image comprising a predetermined fraction of the bit map,
c) determining whether the correspondence between the individual's bit map and the partial image meets certain predetermined criteria, and
d) indicating acceptance or rejection of the candidate.

2. The method defined in claim 1, wherein step © uses autocorrelation to generate a template in the form of a compressed and encrypted two dimensional image using all the features in the bit map image.

3 The method defined in claim 2, wherein a cross correlation procedure is used directly on the bit map and clone images to express the degree of sameness between those two images by substituting and comparing the templates that represent them

4. The method defined in claim 3, wherein the autocorrelation procedure is performed directly on the images.

5. The method defined in claim 4, identification and verification or rejection by cross-correlating two templates is accomplished in a fraction of a second

6. The method defined in claim 2, wherein the procedure is performed on templates of different shapes and different diagnostic values generated according to whether the scan direction is vertical, horizontal, or from facial centerline outward.

7. The method defined in claim 6, wherein such templates are used in combination to augment the identification process.

8. The method defined in claim 4, wherein the autocorrelation identification process does not require a perfect match score (r²=1.000) to accept a Candidate, and. a match score between Candidate and Reference templates that is equal to or exceeds a predetermined threshold score will accept the Candidate.

9. The method defined in claim 8, wherein an Error Rate Program is employed to assess the error rate performance of the biometric identification apparatus and to establish a threshold score to be set into the identification apparatus as a criterion to accept or reject the Candidate.

10. The method defined in claim 9, wherein the Error Rate Program is employed to test performance of modifications to the identification apparatus so as to optimize the apparatus for a specific use.

11. The method defined in claim 2, wherein the compression and encryption of a two dimensional digital image is achieved by compressing a typical 500 KB facial bit map (500×10³×8=4×10⁶ bits), to an irregular template in the order of 50 points (50×8=4×10² bits), achieving a Compression Ratio of 10,000:1. with an Autocorrelation process

12. The method defined in claim 2, including the further step of storing the compressed facial images (templates) in a digital camera memory along with templates of other Candidates.

13. The method defined in claim 12, wherein the stored templates effectively encrypt each facial image so that such images cannot be reverse engineered to recover the facial image

14. The method defined in claim 12, wherein the digital memory is capable of storing and retrieving any selected one of several thousand 50-point templates within a time lapse in the order of a few milliseconds.

15. The method defined in claim 2, wherein an digital camera of ordinary appearance is used, and the camera is located to view persons in or moving through publicly accessible areas and take/record encrypted facial images (templates) of such persons.

16. The method defined in claim 15, wherein the camera is connected to a remotely located database for purposes of off-site storage and/or processing.

17. The method defined in claim 5; wherein comparison of Candidate and Reference templates is accomplished by electronically sliding one template over the other stepwise and testing the resulting correlation curve for the degree of symmetry.

18. The method defined in claim 5, wherein comparison os Candidate and Reference templates is initiated by establishing the starting scan line of the Parent image against which the ensuing image correlation will take place.

19. Apparatus for identifying an individual based on a facial image, comprising
means for preparing a digital bit map of an individual Candidate's face,
means for creating a digital clone image containing a predetermined fraction of the bit map,
means for determining whether the correspondence between the individual's bit map and the partial image meets predetermined criteria, and
means for indicating acceptance/rejection of the candidate.

20. The apparatus defined in claim 19, including computer means for performing autocorrelation to generate a template in the form of a compressed and encrypted two dimensional image using all the features in the bit map digital image.

21. The apparatus defined in claim 20, further including means for performing a cross-correlation procedure on the bit map and clone images to determne the degree of sameness between those two images by substituting and comparing the templates that represent them

22. The apparatus defined in claim 20, further including means for performing the procedure on templates of different shapes and different diagnostic values according to whether the scan direction is vertical, horizontal, or from facial centerline outward.

23. The apparatus defined in claim 22, further including means for performing cross-correlation on such templates used in combination to augment the identification process.

24. The apparatus defined in claim 20, including means for creating an Error Rate Program and employing it to assess the error rate performance of the biometric identification apparatus and to establish a threshold score to be set into the identification apparatus as a criterion to accept or reject the Candidate.

25. The apparatus defined in claim 24, including means for applying the Error Rate Program to test performance of modifications to the identification apparatus so as to optimize the apparatus for a specific use.

26. The apparatus defined in claim 20, wherein said means for performing autocorrelation is capable of compression and encryption of a two dimensional digital image is achieved by compressing a typical 500 KB facial bit map (500×10³8=4×10⁶ bits), to an irregular template in the order of 50 points (50×8=4×10² bits), achieving a Compression Ratio of 10,000:1. with an Autocorrelation process

27. The apparatus defined in claim 20, including a digital camera having a memory for storing the templates along with templates of other Candidates.

28. The apparatus defined in claim 27, wherein said memory stores templates which effectively encrypt each facial image so that such images cannot be reverse engineered to recover the facial image

29. The apparatus defined in claim 27, wherein said digital camera memory is capable of storing and retrieving any selected one of several thousand 50-point templates within a time lapse in the order of a few milliseconds.

30. The apparatus defined in claim 20, further including a digital camera of ordinary appearance located to view persons in or moving through publicly accessible areas and take/record encrypted facial images (templates) of such persons.

31. The apparatus defined in claim 30, wherein said camera is connected to a remotely located database for purposes of off-site storage and/or processing.

17. The method defined in claim 5, wherein comparison of Candidate and Reference templates is accomplished by electronically sliding one template over the other stepwise and testing the resulting correlation curve for the degree of symmetry.

18. The method defined in claim 5, wherein comparison os Candidate and Reference templates is initiated by establishing the starting scan line of the Parent image against which the ensuing image correlation will take place.
